(19) United States
(12) Patent Application Publication
(10) Pub. No.: US 2023/0221489 A1
(43) Pub. Date: Jul. 13, 2023

(54) METASURFACE OPTICAL DEVICE AND OPTICAL APPARATUS

(71) Applicant: Shphotonics Ltd, Suzhou (CN)

(72) Inventors: Lei SUN, Suzhou (CN); Bing QIU, Suzhou (CN)

(21) Appl. No.: 18/153,525

(22) Filed: Jan. 12, 2023

(30) Foreign Application Priority Data
Jan. 13, 2022 (CN) 202220088637.0

(51) Int. Cl. G02B 6/122; B82Y 20/00; G02B 1/00

(52) U.S. Cl. CPC G02B 6/1225; B82Y 20/00; G02B 1/002

(57) ABSTRACT

A metasurface optical device includes a substrate and a nano-structure layer disposed on the substrate. The nano-structure layer includes a plurality of composite nano units each including a plurality of nano-structure units arranged on the substrate. Arrangement periods of the plurality of composite nano units are not completely same, and arrangement periods of the plurality of nano-structure units in one composite nano unit of the plurality of composite nano units are not completely same.

### CROSS-REFERENCE TO RELATED APPLICATION

This application claims priority to Chinese Application No. 202220088637.0, filed on Jan. 13, 2022, the entire content of which is incorporated herein by reference.

### TECHNICAL FIELD

The present disclosure relates to the metasurface technology and, in particular, to a metasurface optical device and an optical apparatus.

### BACKGROUND

Metasurface refers to an artificial two-dimensional material with the sizes of basic structure units smaller than the working wavelengths and usually in the order of nanometers in the near-infrared and visible band. Metasurface can realize flexible and effective control of the characteristics, such as propagation direction, polarization mode, amplitude, and phase, of electromagnetic waves.

Metasurface can be used to make ultra-light, ultra-thin, and multifunctional optical devices. Compared with conventional optical devices, a metasurface optical device manufactured based on semiconductor technology has the advantages of excellent optical performance, small size, and high integration. Metasurface optical devices can be widely used in future portable and miniaturized devices, such as augmented reality wearable devices, virtual reality wearable devices, and mobile terminal lenses.

How to improve the optical properties and imaging qualities of the metasurface optical devices is an important direction for the researchers in this field.

### SUMMARY

In accordance with the disclosure, there is provided a metasurface optical device including a substrate and a nano-structure layer disposed on the substrate. The nano-structure layer includes a plurality of composite nano units each including a plurality of nano-structure units arranged on the substrate. Arrangement periods of the plurality of composite nano units are not completely same, and arrangement periods of the plurality of nano-structure units in one composite nano unit of the plurality of composite nano units are not completely same.

Also in accordance with the disclosure, there is provided an optical apparatus including a metasurface optical device. The metasurface optical device includes a substrate and a nano-structure layer disposed on the substrate. The nano-structure layer includes a plurality of composite nano units each including a plurality of nano-structure units arranged on the substrate. Arrangement periods of the plurality of composite nano units are not completely same, and arrangement periods of the plurality of nano-structure units in one composite nano unit of the plurality of composite nano units are not completely same.

### BRIEF DESCRIPTION OF THE DRAWINGS

Embodiments of the present disclose will be described below with reference to the accompanying drawings to provide further details, features, and advantages of the present disclosure.

FIG. 1 is a schematic diagram showing the principle of chromatic aberration generation when imaging using a lens.

FIG. 2 is a schematic diagram showing the principle of chromatic aberration generation when imaging using a metasurface optical device.

FIG. 3A is a schematic structural diagram of an exemplary metasurface optical device according to some embodiments of the present disclosure.

FIG. 3B is a cross-sectional view along A-A in FIG. 3A.

FIG. 4 is a schematic diagram showing an exemplary arrangement of a plurality of composite nano units of a metasurface optical device according to some embodiments of the present disclosure.

FIG. 5A is a graph showing normalized values of light intensity of lights of different colors as a function of a focal length after passing through a metasurface optical device without chromatic aberration correction.

FIG. 5B is a graph showing normalized values of light intensity of lights of different colors as a function of a focal length after passing through an exemplary metasurface optical device according to some embodiments of the present disclosure.

FIG. 5C is a graph showing normalized values of light intensity of lights of different colors as a function of a focal length after passing through another exemplary metasurface optical device according to some embodiments of the present disclosure.

FIG. 6 is a schematic structural diagram of an exemplary optical apparatus according to some embodiments of the present disclosure.

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

A property that a refractive index of a material changes with a frequency of incident light is called “dispersion.” For example, a thin beam of white light can be divided into seven colors of red, orange, yellow, green, blue, indigo, and purple by a prism. This is because the prism has different refractive indices for different colors in a polychromatic light. When the lights of different colors pass through the prism, directions of propagation thereof are deflected to different degrees. Thus, when leaving the prism, the lights of different colors are dispersed respectively.

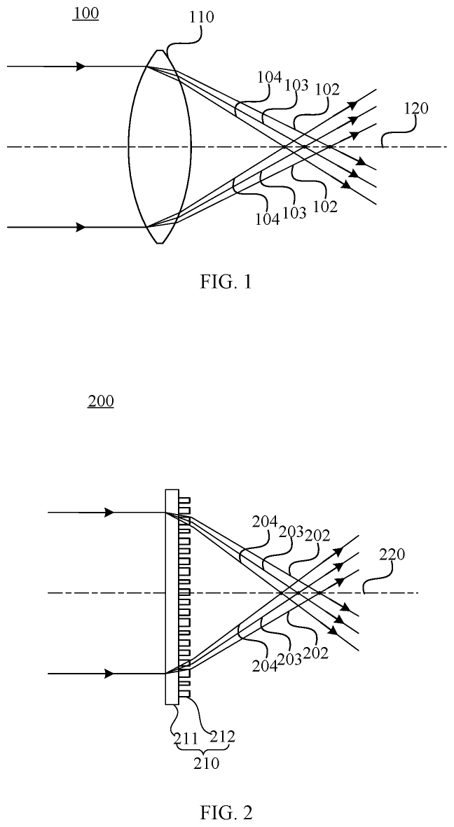

FIG. 1 is a schematic diagram 100 showing the principle of chromatic aberration generation when imaging using a lens 100. When the lens 110 is used to form an image, lights with different colors (red light 102, green light 103, and blue light 104 shown in FIG. 1) form dispersion. Aberration caused by differences in optical lengths and refraction angles of lights of different colors is called chromatic aberration. Optical length can be understood as a distance traveled by light in a vacuum within a same time, which equals a product of a refractive index of a medium and a distance the light propagates in the medium. The chromatic aberration may include a positional chromatic aberration and a magnification chromatic aberration due to different properties. The positional chromatic aberration describes differences in imaging positions of lights of different colors on an optical axis 120 (as shown in FIG. 1), and the magnification chromatic aberration describes differences in image sizes caused by different imaging heights (i.e., magnifications) of lights of different colors. The chromatic aberration significantly affects imaging properties of an optical system. Thus, chromatic aberration needs to be corrected for high quality imaging, such as using a proper combination of converging lens and diverging lens to reduce the chromatic aberration.

FIG. 2 is a schematic diagram 200 showing the principle of chromatic aberration generation when imaging using a metasurface optical device. As shown in FIG. 2, a metasurface optical device 210 includes a substrate 211 and a nano-structure layer 212. The nano-structure layer 212 includes a plurality of columnar nano-structure units. The metasurface optical device 210 has a light converging effect substantially equivalent to that of the lens 110 shown in FIG. 1, and also has the chromatic aberration similar to that shown in FIG. 1. As shown in FIG. 2, when the metasurface optical device 210 is used for imaging, lights of different colors (red light 204, green light 203, and blue light 202 shown in FIG. 2) form the positional chromatic aberration on an optical axis 220.

One solution to correct the chromatic aberration of the metasurface optical device is to attach one or more lens to a back side of the substrate of the metasurface optical device, that is, the side of the substrate facing away from the nano-structure unit, to achieve the effect of reducing the chromatic aberration. However, such a solution requires a very high precision in a lens bonding process. Moreover, limited by a surface shape and a thickness of the lens, an overall structure is more complicated, an overall thickness increases, thereby making it undesirable to be assembled with other structures.

The embodiments of the present disclosure provide a metasurface optical device and an optical apparatus including the metasurface optical device, so as to improve the optical performance of the metasurface optical device.

In some embodiments, the nano-structure layer includes a plurality of composite nano units with different arrangement periods. Each composite nano unit includes a plurality of nano-structure units arranged on the substrate with different arrangement periods. Based on the design, the chromatic aberration of the metasurface optical device can be adjusted, for example, the chromatic aberration can be reduced or increased, thereby improving the optical performance of the metasurface optical device. Compared with related technologies, since there is no need to attach lenses to the back side of the substrate, the thickness of the metasurface optical device is thinner, and an ultra-thin design is more likely to be achieved.

In the embodiments of the present disclosure, specific product types of the optical apparatus including the metasurface optical device are not limited. For example, the optical apparatus may be a lens of an augmented reality wearable device, a virtual reality wearable device, a mobile terminal, or a spectrometer, a microscope, a telescope, or the like.

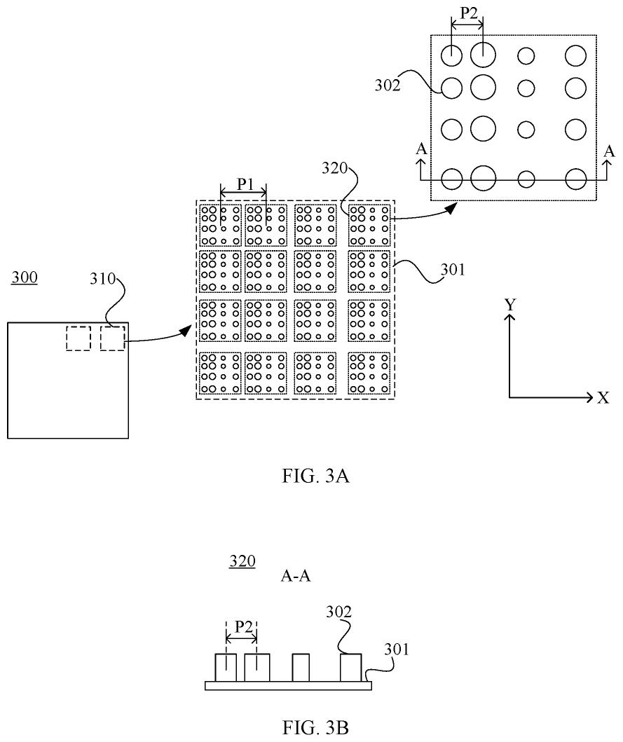

FIG. 3A and FIG. 3B show a metasurface optical device 300 consistent with the present disclosure. The metasurface optical device 300 includes a substrate 301 and a nano-structure layer disposed on the substrate 301. The nano-structure layer includes a plurality of composite nano units 320. Each composite nano unit 320 includes a plurality of nano-structure units 302 arranged on the substrate 301. The arrangement periods P1 of the plurality of composite nano units 320 are not completely the same. In each composite nano unit 320, the arrangement periods P2 of the plurality of nano-structure units 302 are not completely the same.

In the specification, phrases like “parameters B of a plurality of A's are not completely the same” mean that the plurality of A's are intentionally designed such that the parameters B of the plurality of A's formed by the manufacturing process are not all the same. Thus, these parameters B that are not all the same should not be interpreted as the result of errors in the manufacturing process, and vice versa. For example, “the dimensions of the plurality of nano-structure units in the direction perpendicular to the substrate are not completely the same” means that the plurality of nano-structure units are designed in a way that their vertical dimensions are not all the same, and the difference in the vertical dimensions is not due to manufacturing process errors or measurement errors.

In some embodiments, various nano-structure units 302 in the plurality of composite nano units 320 are arranged such that the plurality of composite nano units 320 have corresponding physical parameters. The physical parameters of the plurality of composite nano units 320 may be the same or not completely the same. The physical parameters include, for example, at least one of wavelength modulation parameters, polarization modulation parameters (e.g., polarization angle, polarization amplitude), beam deflection angle modulation parameters, phase parameters, or focal lengths. That is, the composite nano unit 320 serves as a unit for modulating wavelength, polarization, angle, phase, focal length, etc. The physical parameters of different composite nano units 320 may be the same or not completely the same.

Within each composite nano unit 320, adjacent nano-structure units 302 are separated by a gap. A nano-structure unit 302 is the smallest unit for controlling light in the nano-structure layer, and a structural size thereof is smaller than an operation wavelength, usually on the order of nanometers. Because the material of the nano-structure unit 302 is different from a medium in the gap (e.g., air), their refractive indices are also different, and phases of the light after passing through the nano-structure unit 302 and the gap are also different. In each composite nano unit 320, the arrangement periods of the plurality of nano-structure units 302 are not completely the same, and at least one of the shape, dimension, material, or orientation (e.g., an angle relative to a certain reference direction) of the plurality of nano-structure units 302 is not completely the same. After the light passes through the nano-structure unit 302, a phase delay is generated. By designing a degree of phase delay caused by each nano-structure unit 302, the metasurface optical device 300 may realize corresponding optical functions, such as realizing functions of a converging lens, a diverging lens, or a grating.

In some embodiments, the arrangement periods P1 of the plurality of composite nano units 320 can be broadly construed as distances between respective geometric centers of adjacent composite nano units 320 along a certain dimension of the arrangement. The arrangement periods of the plurality of composite nano units 320 are not completely the same, that is, there are at least two periods that are not equal. In one example, the plurality of composite nano units 320 are equally sized but unequally spaced along one or more dimensions. In another example, the plurality of composite nano units 320 are equally spaced but unequal in size along one or more dimensions. In another example, the plurality of composite nano units 320 are unequally spaced and unequally sized along one or more dimensions. All of these examples may result in that the arrangement periods of the plurality of composite nano units 320 are not completely the same. Any one of the above methods may be used when designing the variable periods of the plurality of composite nano units 320.

Similarly, the arrangement periods P2 of the plurality of nano-structure units 302 can be broadly construed as distances between respective geometric centers of adjacent nano-structure units 302 along a certain dimension of the arrangement. The arrangement periods of the plurality of nano-structure units 302 are not completely the same, that is, there are at least two periods that are not equal. In one example, the plurality of nano-structure units 302 are equally sized but unequally spaced along one or more dimensions. In another example, the plurality of nano-structure units 302 are equally spaced but unequally sized along one or more dimensions. In another example, the plurality of nano-structure units 302 are unequally spaced and unequally sized along one or more dimensions. All these examples may result in that the arrangement periods of the plurality of nano-structure units 302 are not completely the same. Any one of the above-mentioned methods may be used when designing the variable periods of the plurality of nano-structure units 302.

Based on the variable-period arrangement design of the composite nano unit 320 and the variable-period arrangement design of the nano-structure unit 302 in the composite nano-unit 320, optical length differences of lights of different colors is optimized, such that the chromatic aberration of the metasurface optical device 300 is adjusted. For example, the chromatic aberration of the metasurface optical device 300 is reduced or increased, thereby improving the optical performance of the metasurface optical device 300.

In addition, compared with the related art, the technical solution of the embodiments of the present disclosure does not need to attach a lens to the back side of the substrate 301. Thus, the metasurface optical device 300 is thinner, and an ultra-thin design is more likely to be achieved.

Overall shape and size of the composite nano unit 320 are not limited. For example, the shape of the orthogonal projection of the composite nano unit 320 on the substrate 301 may be roughly triangular, square, hexagonal, circular, elliptical, ring, or fan-shaped, etc., and the shape may be symmetrical or asymmetrical. Designing the shape of the composite nano unit 320 to be at least partially symmetrical can help to reduce or eliminate polarization-related effects.

In some embodiments, the sizes of the plurality of composite nano units in at least one dimension of a planar coordinate system vary based on a first rule. The planar coordinate system is, for example, a Cartesian coordinate system (including two dimensions of an X axis and a Y axis) or a polar coordinate system (including two dimensions of a polar radius p and a polar angle θ).

In some embodiments, the first rule is, for example, that in the Cartesian coordinate system, along the X axis direction, the sizes of the plurality of composite nano units increase and the spacings thereof remain constant, and along the Y axis direction, the sizes of the plurality of composite nano units increase and the spacings thereof remain constant, resulting in changes of the arrangement periods of the composite nano units in both dimensions.

In some other embodiments, the spacings between adjacent composite nano units 320 in the plurality of composite nano units 320 in at least one dimension of the planar coordinate system vary based on a second rule. In some embodiments, the second rule is, for example, that in the Cartesian coordinate system, along the X axis direction, the sizes of the plurality of composite nano units 320 remain constant and the spacings thereof increase, and in the Y axis direction, the sizes of the plurality of composite nano units 320 remain constant and the spacings thereof increase, resulting in changes of the arrangement periods of the composite nano units 320 in both dimensions. As shown in FIG. 3A, the plurality of composite nano units 320 have the same shape and size, and in the Cartesian coordinate system, the spacings along the X axis direction increase and the spacings along the Y axis direction increase. The drawing only shows one of the variable-period arrangements of the composite nano units, and designs of actual products may be changed according to actual needs.

In some other embodiments, the sizes of the plurality of composite nano units in at least one dimension of the planar coordinate system vary based on the first rule, and at the same time, the spacings between adjacent composite nano units in the plurality of composite nano units in at least one dimension of the planar coordinate system vary based on the second rule.

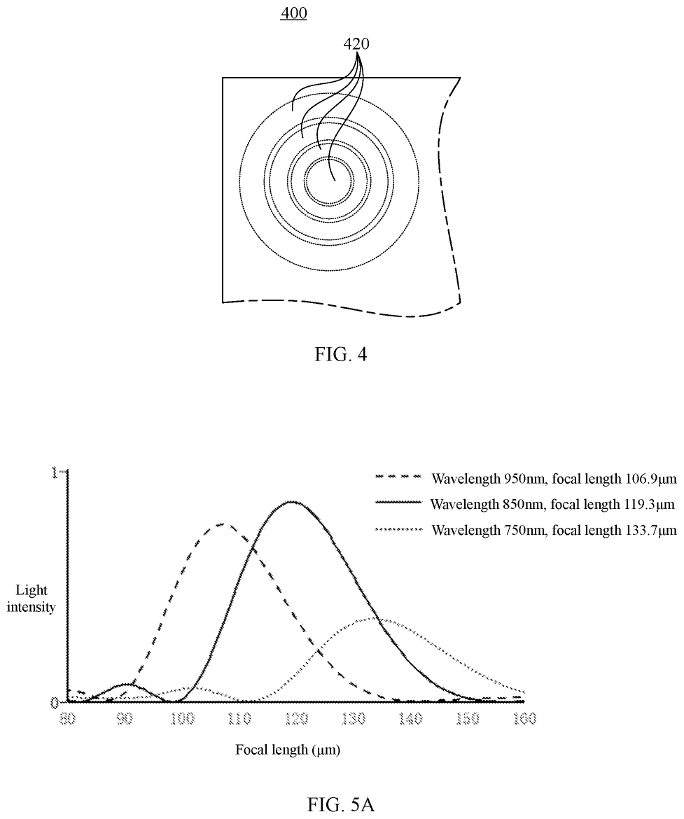

In the embodiments shown in FIG. 3A, the plurality of composite nano units 320 in the metasurface optical device 300 are arranged in a periodic array. FIG. 4 shows a metasurface optical device 400 consistent with some other embodiments of the disclosure. As shown in FIG. 4, a plurality of composite nano units 420 in the metasurface optical device 400 are nested and arranged sequentially along a radial direction of a circle. Along the radial direction of the circle, the size and/or spacing of the plurality of composite nano units 400 may also exhibit a certain variation trend, such as increasing or decreasing. In some other embodiments, the plurality of composite nano units 420 in the metasurface optical device 400 may also be arranged sequentially along a circumferential direction of the circle.

In some embodiments, parameters such as the shape, size, and orientation of the composite nano units 420 are not limited. At least one parameter among the shape, size, and orientation (e.g., an angle relative to a certain reference direction) of the plurality of composite nano units 420 may not be completely the same. For example, the shapes of the plurality of composite nano units 420 may not be completely the same, the sizes of the plurality of composite nano units 420 may not be completely the same, the orientations of the plurality of composite nano units 420 may not be completely the same, etc.

The plurality of nano-structure units 302 in the composite nano unit 320 may be nanopillar units, that is, columnar structures protruding from the substrate 301, as shown in FIG. 3B. In some other embodiments, the plurality of nano-structure units in the composite nano unit may also be nanohole units, that is, a plurality of hole structures formed in the nano-structure layer. In some other embodiments, some of the plurality of nano-structure units in the composite nano unit may be nanopillar units and some other may be nanohole units. Within the composite nano unit, the plurality of nano-structure units may be arranged with reference to the Cartesian coordinate system or the polar coordinate system.

In some embodiments, in a composite nano unit 320, the parameters such as the shape, size, material, and orientation of the nano-structure unit 302 are not limited. At least one parameter among the shape, size, material, and orientation of the plurality of nano-structure units 302 may not be completely the same. For example, the shapes of the orthogonal projections of the plurality of nano-structure units 302 on the substrate 301 may not be completely the same, and the sizes of the plurality of nano-structure units 302 in the direction perpendicular to the substrate 301 may not be completely the same. Tilt angles of the plurality of nano-structure units 302 relative to the substrate 301 may not be completely the same, the orientations of the plurality of nano-structure units 302 may not be completely the same, and so on. When designing the composite nano-unit 320, the change of the shape and size of the nano-structure unit 302 is combined with the periodic change of the nano-structure unit 302, thereby making it easier to adjust the chromatic aberration and simplifying process complexity.

In some embodiments, in each composite nano unit, the sizes of the plurality of nano-structure units in at least one dimension of the planar coordinate system vary based on a third rule. The third rule is, for example, that the sizes of the plurality of nano-structure units in at least one dimension of the planar coordinate system increase, decrease, or change periodically (for example, increase and decrease alternately). In some embodiments, in the Cartesian coordinate system, along the X axis direction, the sizes of the plurality of nano-structure units increase and the spacings remain constant, and along the Y axis direction, the sizes of the plurality of nano-structure units increase and the spacings remain constant, thereby resulting in changes of the arrangement periods of the plurality of nano-structure units in both dimensions.

In some other embodiments, as shown in FIG. 3A, in each composite nano unit 320, the spacings between adjacent nano-structure units 302 in the plurality of nano-structure units 302 in at least one dimension of the planar coordinate system vary based on a fourth rule. The fourth rule is, for example, that the spacings between adjacent nano-structure units 302 in the plurality of nano-structure units 302 increase, decrease, or change periodically (for example, increase and decrease alternately) in at least one dimension of the planar coordinate system. As shown in FIG. 3A, in the Cartesian coordinate system, along the X axis direction, the sizes of the plurality of nano-structure units 302 remain constant and the spacings increase, and along the Y axis direction, the sizes of the plurality of nano-structure units 302 remain constant and the spacing increase, resulting in changes of the arrangement periods in the plurality of nano-structure units 302 in both dimensions. In addition, the plurality of nano-structure units 302 may have different materials, arrangements, shapes, and heights. The drawing only shows one of the variable-period arrangements of the plurality of nano-structure units 302 in the composite nano unit 320, and the designs of the actual products may be changed according to actual needs.

In some embodiments, in each composite nano unit, the sizes of the plurality of nano-structure units in at least one dimension of the planar coordinate system vary based on the third rule, and at the same time, the spacings between adjacent nano-structure units in at least one dimension of the planar coordinate system vary based on the fourth rule.

In the above embodiments of the present disclosure, the arrangement periods of the plurality of composite nano units 320 and the arrangement periods of the plurality of nano-structure units 302 in the composite nano unit 320 have a linear variation trend in at least one dimension, thereby exhibiting characteristics similar to a chirped grating. Through the corresponding structural design, the distance traveled by the light with a shorter wavelength after passing through the nano-structure layer may be increased, and/or the distance traveled by the light with a longer wavelength after passing through the nano-structure layer may be decreased, such that the optical length difference of the lights of different colors in the nano-structure layer can be corrected and the chromatic aberration can be reduced. Conversely, through corresponding structural design, for example, designing the arrangement periods of the plurality of nano-structure units 302 in the composite nano unit 320 as special change arrangement periods, the dispersion may be further increased, thereby achieving an increase in the chromatic aberration.

In some embodiments, the plurality of composite nano units 320 may be divided into a plurality of levels based on optimization capabilities of different physical parameters of light. For example, a first-level composite nano unit includes a plurality of corresponding subsets of second-level composite nano units for modulating one or more physical parameters of light. A second-level composite nano unit includes a plurality of corresponding subsets of third-level composite nano units for modulating another one or more physical parameters of light. A third-level composite nano unit is the lowest composite nano unit, including a plurality of nano-structure units arranged on the substrate, and is configured to modulate another one or more physical parameters of the light. An order of magnitude of the size of the first-level composite nano unit may be set proportionally according to an order of magnitude of the size of the metasurface optical device 300. For example, the order of magnitude of the size of the first-level composite nano unit is approximately one hundredth of the order of magnitude of the size of the metasurface optical device 300.

Referring again to FIG. 3A, the nano-structure layer may include a plurality of functional regions 310. Each functional region 310 includes a corresponding subset of a plurality of composite nano units 320. The plurality of composite nano units 320 are arranged such that the plurality of functional regions 310 have mutually different optical functions. For example, the plurality of functional regions 310 respectively implement optical convergence at different focal positions, or respectively implement different grating functions.

An order of magnitude of the size of the functional region 310 may be equal to or slightly smaller than the order of magnitude of the size of the metasurface optical device 300, and significantly larger than the order of magnitude of the size of the first-level composite nano unit. For example, the size of the metasurface optical device 300 and the functional region 310 is on the order of centimeters, and the size of the first-level composite nano unit is on the order of hundreds of microns.

The specific arrangements of the plurality of functional regions 310 are not limited. For example, the plurality of functional regions 310 may be arranged in an array, arranged sequentially along the circumferential direction of a circle, or nested in sequence along the radial direction of a circle, and so on. In addition, the plurality of functional regions 310 may also be arranged in two or more different ways. The shape, size, and arrangement of the plurality of functional regions 310 may be designed based on specific applications of the metasurface optical device 300, and can be, for example, square, hexagonal, circular, trapezoidal, fan-shaped, etc.

In some embodiments, the nano-structure layer is not divided into the plurality of functional regions, and the nano-structure layer as a whole is used to realize an optical function, such as light convergence.

In some embodiments, the metasurface optical device may further include a protective layer on a side of the nano-structure layer facing away from the substrate. The protective layer may be, for example, a planarization layer or protective glass, which protects the nano-structure layer and facilitates lamination or assembly with other structures.

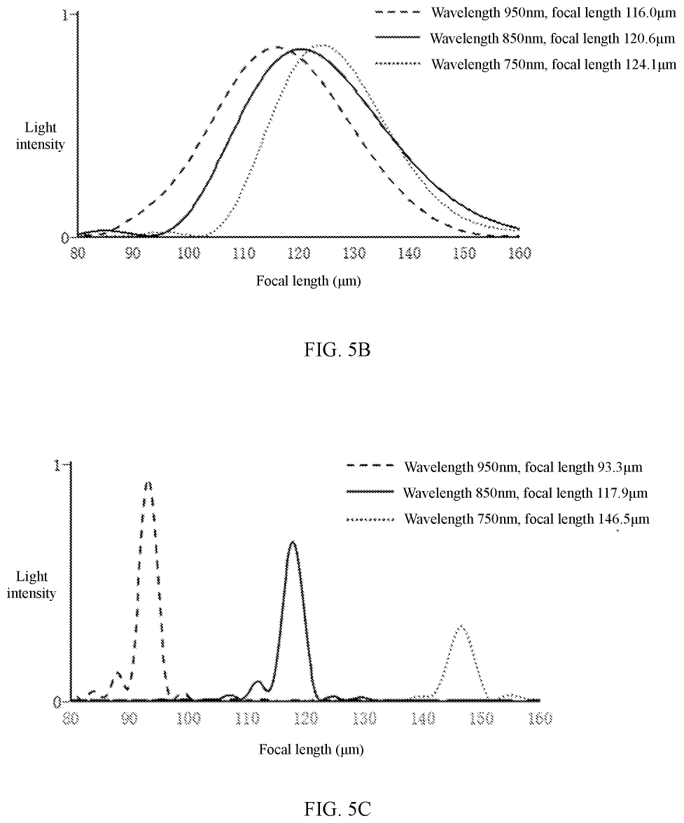

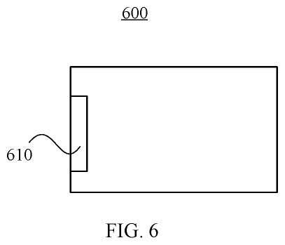

FIG. 5A is a graph showing normalized values of light intensity of lights of different colors as a function of a focal length after passing through a metasurface optical device. Peaks of the curves of the lights with wavelengths of 750 nm, 850 nm, and 950 nm correspond to focal lengths of 133.7 μm, 119.3 μm, and 106.9 μm, respectively. The focal lengths are obviously different, resulting in the chromatic aberration.

FIG. 5B is a graph showing normalized values of light intensity of lights of different colors as a function of a focal length after passing through an exemplary metasurface optical device according to some embodiments of the present disclosure. In some embodiments, the arrangement periods of the plurality of composite nano units and the arrangement periods of the plurality of nano-structure units adopt a variable-period arrangement design to reduce the chromatic aberration. Peaks of the curves of the lights with wavelengths of 750 nm, 850 nm, and 950 nm correspond to focal lengths of 124.1 μm, 120.6 μm, and 116.0 μm, respectively. Comparing FIG. 5B with FIG. 5A, it can be seen that differences of the focal lengths in FIG. 5B are significantly reduced, thereby reducing the chromatic aberration of the three lights with different colors.

FIG. 5C is a graph showing normalized values of light intensity of lights of different colors as a function of a focal length after passing through another exemplary metasurface optical device according to some embodiments of the present disclosure. In some embodiments, the arrangement periods of the plurality of composite nano units and the arrangement periods of the plurality of nano-structure units adopt the variable-period arrangement design to increase the chromatic aberration. Peaks of the curves of the lights with wavelengths of 750 nm, 850 nm, and 950 nm correspond to focal lengths of 146.5 μm, 117.9 μm, and 93.3 μm, respectively. Comparing FIG. 5C with FIG. 5A, it can be seen that differences of the focal lengths in FIG. 5C are significantly increased, thereby increasing the chromatic aberration of the three lights with different colors.

In the embodiments of the present disclosure, types of the material of the substrate 301 are not limited. For example, the substrate 301 may include any one of glass, quartz, polymer, and plastic. Types of the material of the nano-structure layer are not limited. For example, the nano-structure layer may include at least one of single crystal silicon, polycrystalline silicon, amorphous silicon, silicon carbide, titanium dioxide, germanium, silicon nitride, or group III-V compounds. The group III-V compounds are compounds formed by boron, aluminum, gallium, indium of group III in the periodic table of elements, and nitrogen, phosphorus, arsenic, antimony of group V in the periodic table of elements, such as gallium phosphide, gallium nitride, gallium arsenide, indium phosphide, etc.

The present disclosure also provides an optical apparatus 600 including a metasurface optical device 610. The metasurface optical device 610 may be a metasurface optical device consistent with the disclosure, such as one of the example metasurface optical devices described above. Specific product types of the optical apparatus 600 are not limited. For example, the optical apparatus 600 may be a lens of an augmented reality wearable device, a virtual reality wearable device, a mobile terminal, etc., or a spectrometer, a microscope, a telescope, or the like. Because the optical performance of the metasurface optical device 610 is improved, the optical apparatus 600 also has the desired optical performance.

Several different embodiments or examples are described in the present disclosure. These embodiments or examples are exemplary and are not intended to limit the scope of the present disclosure. Those skilled in the art can conceive of various modifications or substitutions based on the disclosed contents, and such modifications and substitutions should be included in the scope of the present disclosure. A true scope and spirit of the invention is indicated by the following claims.

What is claimed is:

1. A metasurface optical device comprising:
a substrate; and
a nano-structure layer disposed on the substrate, the nano-structure layer including a plurality of composite nano units each including a plurality of nano-structure units arranged on the substrate;
wherein:
arrangement periods of the plurality of composite nano units are not completely same; and
arrangement periods of the plurality of nano-structure units in one composite nano unit of the plurality of composite nano units are not completely same.

2. The metasurface optical device of claim 1, wherein sizes of the plurality of composite nano units in at least one dimension of a planar coordinate system vary.

3. The metasurface optical device of claim 2, wherein the planar coordinate system is a Cartesian coordinate system or a polar coordinate system.

4. The metasurface optical device of claim 1, wherein spacings between adjacent ones of the plurality of composite nano units in at least one dimension of a planar coordinate system vary.

5. The metasurface optical device of claim 1, wherein:
sizes of the plurality of composite nano units in a first dimension of a planar coordinate system vary based on a first rule; and
spacings between adjacent ones of the plurality of composite nano units in a second dimension of the planar coordinate system vary based on a second rule, the second dimension being same as or different from the first dimension, and the second rule being different from the first rule.

6. The metasurface optical device of claim 1, wherein the plurality of composite nano units are arranged sequentially along a circumferential direction or a radial direction of a circle.

7. The metasurface optical device of claim 1, wherein in the one composite nano unit, sizes of the plurality of nano-structure units in at least one dimension of a planar coordinate system vary.

8. The metasurface optical device of claim 1, wherein in the one composite nano unit, spacings between adjacent ones of the plurality of nano-structure units in at least one dimension of a planar coordinate system vary.

9. The metasurface optical device of claim 1, wherein in the one composite nano unit:
sizes of the plurality of nano-structure units in a first dimension of a planar coordinate system vary based on a first rule; and
spacings between adjacent ones of the plurality of nano-structure units in a second dimension of the planar coordinate system vary based on a second rule, the second dimension being same as or different from the first dimension, and the second rule being different from the first rule.

10. The metasurface optical device of claim 1, wherein in the one composite nano unit, sizes of the plurality of nano-structure units in at least one dimension of a planar coordinate system increase, decrease, or, change periodically.

11. The metasurface optical device of claim 1, wherein in the one composite nano unit, spacings between adjacent ones of the plurality of nano-structure units in at least one dimension of a planar coordinate system increase, decrease, or change periodically.

12. The metasurface optical device of claim 1, wherein:
at least one of a shape, a size, or an orientation of the plurality of composite nano units is not completely same; and/or
in the one composite nano unit, at least one of a shape, a size, or an orientation of the plurality of nano-structure units is not completely same.

13. The metasurface optical device of claim 1, wherein the nano-structure units in each of the plurality of composite nano units are arranged such that the plurality of composite nano units have corresponding physical parameters each including at least one of a wavelength modulation parameter, a polarization modulation parameter, a beam deflection angle modulation parameter, a phase parameter, or a focal length.

14. The metasurface optical device of claim 1, wherein:
the nano-structure layer includes a plurality of functional regions;
each of the plurality of functional regions includes a corresponding subset of the plurality of composite nano units; and
the plurality of composite nano units are arranged such that the plurality of functional regions have mutually different optical functions.

15. The metasurface optical device of claim 14, wherein:
the plurality of functional regions are arranged in an array, arranged sequentially along a circumferential direction of a circle, or nested in sequence along a radial direction of a circle.

16. The metasurface optical device of claim 1, wherein the plurality of nano-structure units include nanopillar units.

17. The metasurface optical device of claim 1, wherein the plurality of nano-structure units include nanohole units.

18. The metasurface optical device of claim 1, wherein the plurality of nano-structure units include nanopillar units and nanohole units.

19. An optical apparatus comprising a metasurface optical device comprising:
a substrate; and
a nano-structure layer disposed on the substrate, the nano-structure layer including a plurality of composite nano units each including a plurality of nano-structure units arranged on the substrate;
wherein:
arrangement periods of the plurality of composite nano units are not completely same; and
arrangement periods of the plurality of nano-structure units in one composite nano unit of the plurality of composite nano units are not completely same.

20. The optical apparatus of claim 19, wherein at least one of sizes of the plurality of composite nano units or spacings between adjacent ones of the plurality of composite nano units in at least one dimension of a planar coordinate system vary.
